(19) United States
(12) Patent Application Publication
(10) Pub. No.: US 2017/0145972 A1
(43) Pub. Date: May 25, 2017

(54) FUEL UNIT PUMP ASSEMBLY COMPRISING AN ISOLATOR

(71) Applicant: GM GLOBAL TECHNOLOGY OPERATIONS LLC, Detroit, MI (US)

(72) Inventors: Gary J. HAZELTON, Oberursel (DE); Iacopo ZALLIO, San Mauro Torinese (Torino) (IT); Riccardo ROSSI, Castelnuovo di Garfagnana (LU) (IT)

(73) Assignee: GM GLOBAL TECHNOLOGY OPERATIONS LLC, Detroit, MI (US)

(21) Appl. No.: 15/357,272

(22) Filed: Nov. 21, 2016

(30) Foreign Application Priority Data
Nov. 20, 2015 (GB) 1520457.1

(51) Int. Cl. F02M 59/44; F02M 37/00

(52) U.S. Cl. CPC F02M 59/44; F02M 37/0011

(57) ABSTRACT

A fuel unit pump assembly includes a fuel unit pump and an isolator. The fuel unit pump includes a pump mounting flange protruding from a pump body. The isolator includes an isolator body having a substantially plate shape and provided with at least one through hole for pump mounting fasteners to couple the pump mounting flange to a first surface of the isolator body. The isolator further includes at least one engine coupling portion protruding from a second surface of the isolator body, opposite to the first surface. The engine coupling portion is provided with at least one through hole for engine mounting fasteners to couple the isolator to an engine structure of the internal combustion engine.

### CROSS-REFERENCE TO RELATED APPLICATION

This application claims priority to Great Britain Patent Application No. 1520457.1, filed Nov. 20, 2015, which is incorporated herein by reference in its entirety.

### TECHNICAL FIELD

The present disclosure pertains to the fuel unit pump of an internal combustion engine, and in particular to the management of the vibration of the fuel unit pump.

### BACKGROUND

According to a possible configuration of the internal combustion engine injection system, a fuel unit pump is provided to supply fuel to the cylinders of the internal combustion engine. Due to their configuration, fuel unit pumps vibrate during operations. In particular, fuel pumps provided with a digital flow control valve (which guarantee lower fuel consumption, improved durability, and cost effectiveness with respect to conventional suction metering units) are typically loud and impart significant structural vibration into the internal combustion engine.

Furthermore, the fuel unit pump is coupled to an engine structure (typically the cylinder head) which also amplifies and radiates the noise of the fuel unit pump. Such a noise is typically perceived as a loud ticking noise radiating from the fuel unit pump and from the engine structure.

Accordingly, there is a need to reduce the noise of the fuel unit pump, while allowing a simple connection between the fuel unit pump and the engine structure to which it is coupled.

### SUMMARY

In accordance with the present disclosure a fuel pump unit is provided to reduce the vibrations transmitted between the fuel unit pump and the above mentioned engine structure of the internal combustion engine, to which the fuel unit pump is coupled.

According to an embodiment, a fuel unit pump assembly includes a fuel unit pump and an isolator. The fuel unit pump includes a pump mounting flange protruding from a pump body. The isolator includes an isolator body having a substantially plate shape, the isolator body being provided with at least one through hole for pump mounting fasteners to couple the pump mounting flange to a first surface of the isolator body. The isolator further includes at least one engine coupling portion protruding from a second surface of the isolator body, opposite to the first surface, the at least one engine coupling portion being provided with at least one through hole for engine mounting fasteners to couple the isolator to an engine structure of the internal combustion engine.

An isolator, also known as tuned isolator, allows the component to vibrate independently from the relevant mounting structure and dissipates the vibration energy as motion. In the present case, the vibrations of the fuel unit pump are isolated from the engine structure and noise production is reduced. Moreover, the fuel unit pump is mounted to the engine structure by means of the isolator. This prevents direct transmission of vibrations between the fuel pump, in particular the body of the fuel pump, and the engine structure of the internal combustion engine.

In more detail, the isolator isolates pump vibration from the engine structure. Isolation allows the pump to vibrate at high frequencies and low displacements. This vibration allows the pump to dissipate its own energy. The isolator can be quite stiff because the frequencies to isolate are very high, therefore low frequency vibration (or displacement), that may cause mounting system failure, are minimized.

Moreover, the coupling portion protrudes from the isolator body. As a result, in operative condition, the isolator body is distanced from the engine structure, so that the isolator body can effectively operate to allow the fuel unit pump to dissipate its own vibration energy as motion without transferring that vibration energy to the engine structure.

According to an embodiment, the isolator includes a through opening for inserting at least a pumping plunger of the fuel unit pump through the through opening. As a result, the isolator is easily coupled to the fuel unit pump.

According to an embodiment, the engine mounting fasteners include a centering bolt. As a result, the fuel unit pump can be easily mounted on and oriented with respect to an engine structure of the internal combustion engine.

According to an embodiment, two through holes for pump mounting fasteners are distanced one two the other by a distance substantially equal to the distance between two through holes for engine mounting fasteners.

Advantageously, a fuel unit pump, which conventionally is mounted directly to the engine structure, can be coupled to the isolator, without the need of modifying or machining the fuel unit pump. In this way, the pre-existing coupling between the fuel unit pump and the engine structure can be used to couple the fuel unit pump to the isolator, in particular to the through holes for the pump mounting fasteners.

Similarly, the through holes for the engine mounting fasteners can be used to couple the isolator to the engine structure at the location on the engine structure that are generally used to couple the fuel unit pump.

According to an embodiment, the isolator is provided with one or more stiffness adjusting recesses or openings, to adjust the stiffness of the isolator. The shape of the isolator can thus be freely chosen, to allow a simple and effective coupling to the fuel unit pump, while the stiffness adjusting recesses or openings allow to choose the proper stiffness to the isolator, in particular the one that allows to provide the required frequency response.

An embodiment of the present disclosure further provides for an internal combustion engine including fuel unit pump assembly according to one or more of the preceding aspects. According to an embodiment, the fuel unit pump assembly is coupled to a cylinder head of the internal combustion engine. Advantageously, the presence of the isolator of the fuel unit pump assembly allows reducing noise of the fuel unit pump, while allowing a simple connection between the fuel unit pump and the engine, e.g. a cylinder head of the internal combustion engine.

### BRIEF DESCRIPTION OF THE DRAWINGS

The present disclosure will hereinafter be described in conjunction with the following drawing figures, wherein like numerals denote like elements.

FIG. 1 shows an embodiment of an automotive system including an internal combustion engine in which the fuel unit pump can be used;

FIG. 2 is a cross-section according to the plane A-A of an internal combustion engine belonging to the automotive system of FIG. 1;

FIG. 3 is a schematic front view of a fuel unit pump assembly according to an embodiment of the present disclosure;

FIG. 4 is a schematic top view of the fuel unit pump assembly of FIG. 3;

FIG. 5 is a schematic, exploded top view of the fuel unit pump assembly of FIGS. 3 and 4; and

FIG. 6 is a schematic top view of an alternative embodiment of an isolator.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

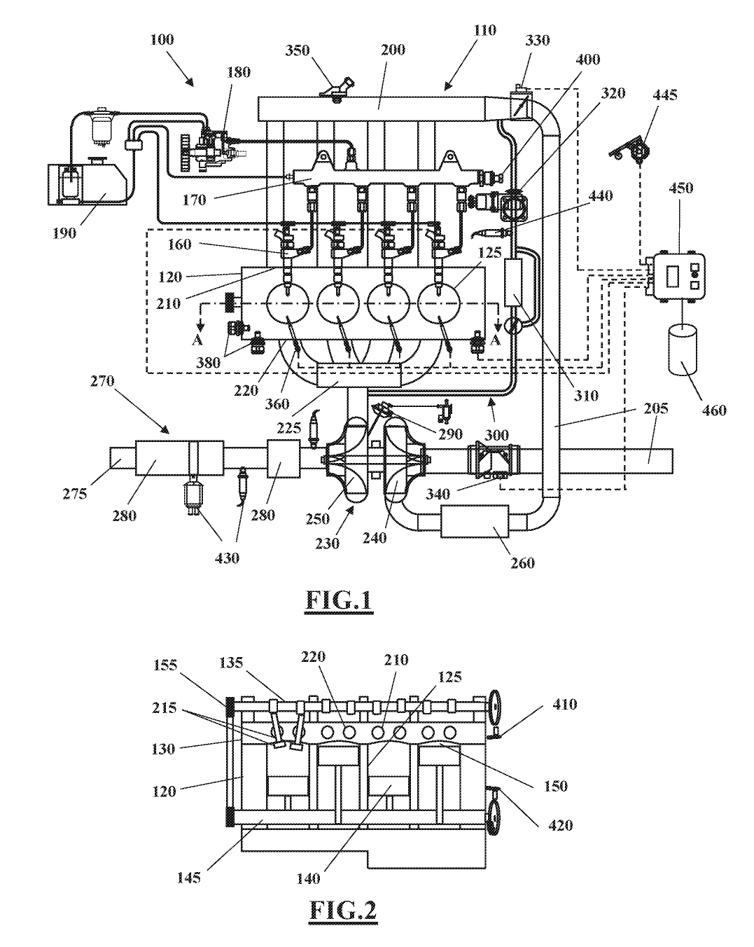

Some embodiments may include an automotive system 100, as shown in FIGS. 1 and 2, that includes an internal combustion engine (ICE) 110 having an engine block 120 defining at least one cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high pressure fuel unit pump 180 that increase the pressure of the fuel received from a fuel source 190. Each of the cylinders 125 has at least two valves 215, actuated by the camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

The air may be distributed to the air intake port(s) 210 through an intake manifold 200. An air intake duct 205 may provide air from the ambient environment to the intake manifold 200. In other embodiments, a throttle body 330 may be provided to regulate the flow of air into the manifold 200. In still other embodiments, a forced air system such as a turbocharger 230, having a compressor 240 rotationally coupled to a turbine 250, may be provided. Rotation of the compressor 240 increases the pressure and temperature of the air in the duct 205 and manifold 200. An intercooler 260 disposed in the duct 205 may reduce the temperature of the air. The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an exhaust system 270. This example shows a variable geometry turbine (VGT) with a VGT actuator 290 arranged to move the vanes to alter the flow of the exhaust gases through the turbine 250. In other embodiments, the turbocharger 230 may be fixed geometry and/or include a waste gate.

The exhaust system 270 may include an exhaust pipe 275 having one or more exhaust aftertreatment devices 280. The aftertreatment devices may be any device configured to change the composition of the exhaust gases. Some examples of aftertreatment devices 280 include, but are not limited to, catalytic converters (two and three way), oxidation catalysts, lean NOx traps, hydrocarbon adsorbers, selective catalytic reduction (SCR) systems, and particulate filters. Other embodiments may include an exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300.

The automotive system 100 may further include an electronic control unit (ECU) 450 in communication with one or more sensors and/or devices associated with the ICE 110. The ECU 450 may receive input signals from various sensors configured to generate the signals in proportion to various physical parameters associated with the ICE 110. The sensors include, but are not limited to, a mass airflow and temperature sensor 340, a manifold pressure and temperature sensor 350, a combustion pressure sensor 360, coolant and oil temperature and level sensors 380, a fuel rail pressure sensor 400, a cam position sensor 410, a crank position sensor 420, exhaust pressure and temperature sensors 430, an EGR temperature sensor 440, and an accelerator pedal position sensor 445. Furthermore, the ECU 450 may generate output signals to various control devices that are arranged to control the operation of the ICE 110, including, but not limited to, the fuel unit pump 180, fuel injectors 160, the throttle body 330, the EGR Valve 320, the VGT actuator 290, and the cam phaser 155. Note, dashed lines are used to indicate communication between the ECU 450 and the various sensors and devices, but some are omitted for clarity.

Turning now to the ECU 450, this apparatus may include a digital central processing unit (CPU) in communication with a memory system 460, or data carrier, and an interface bus. The CPU is configured to execute instructions stored as a program in the memory system, and send and receive signals to/from the interface bus. The memory system 460 may include various storage types including optical storage, magnetic storage, solid state storage, and other non-volatile memory. The interface bus may be configured to send, receive, and modulate analog and/or digital signals to/from the various sensors and control devices.

Instead of an ECU 450, the automotive system 100 may have a different type of processor to provide the electronic logic, e.g. an embedded controller, an onboard computer, or any processing module that might be deployed in the vehicle.

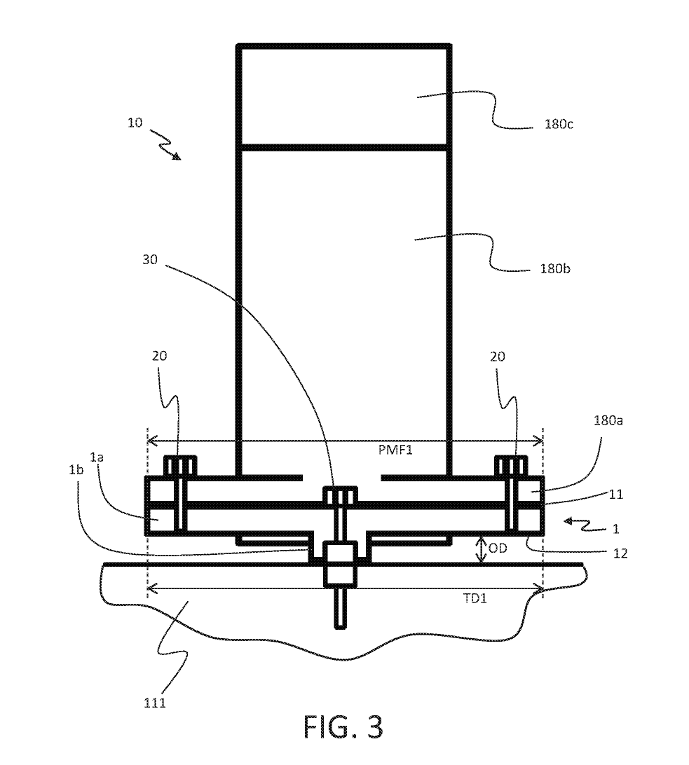

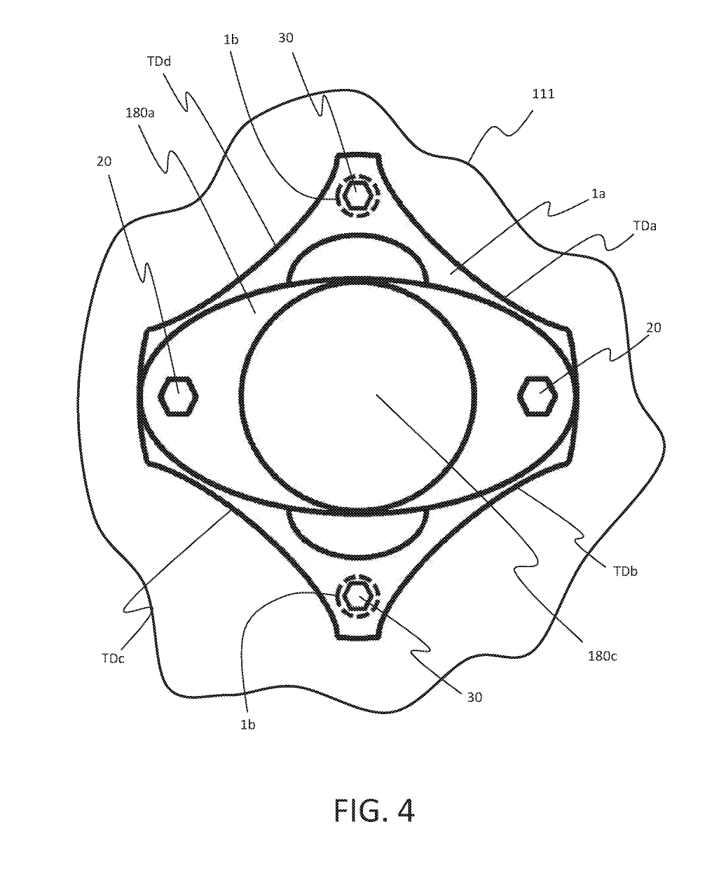

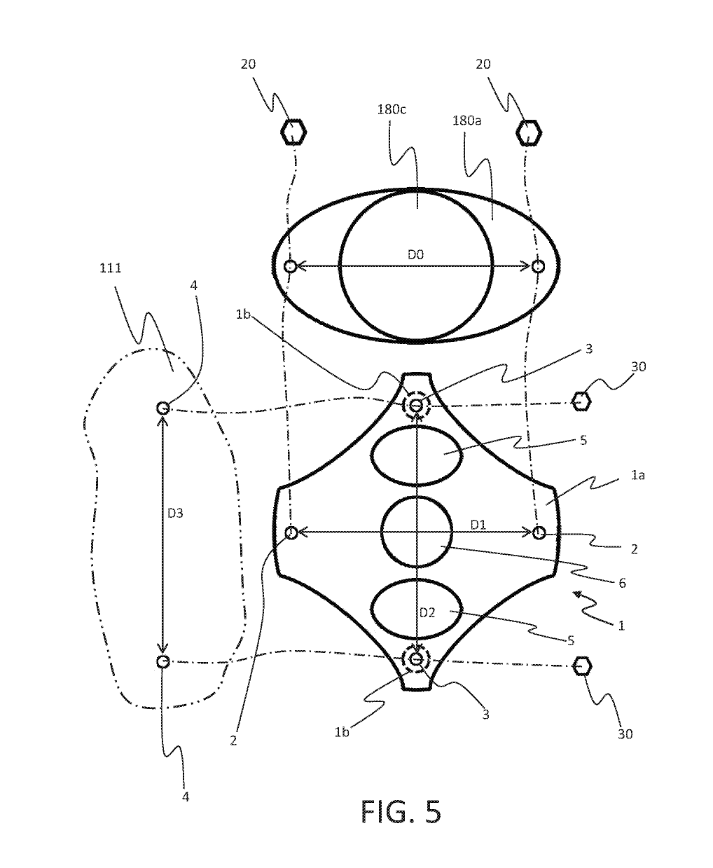

With reference to FIGS. 3-6, a fuel unit pump 180 and an isolator 1 are shown. With particular to FIG. 3, an isolator 1 coupled to a fuel unit pump 180 to form a pump assembly 10 is shown. The fuel unit pump 180 is not shown in detail, as it is known in the art. It generally includes a pump body 180b, typically having a substantially cylindrical shape, and a pump mounting flange 180a protruding laterally from the pump body 180b. Preferably, a digital flow control valve 180c is operatively coupled to the fuel unit pump body 180b, to control the fuel flow rate from the fuel unit pump 180.

The isolator 1 includes an isolator body 1a, which is shaped substantially as a plate, i.e. it is provided with a substantially plate shape. The isolator body la includes a first surface 11 and a second surface 12, opposite to the first surface.

As further detailed below, the first surface 11 of the isolator body 1a is coupled to the fuel pump mounting flange 180a. The second surface 12 of the isolator body 1a is arranged at a distance from the engine structure to which the isolator, and thus the fuel unit pump, is coupled by means of an engine coupling portion.

The isolator body 1a includes one or more through holes 2 for pump mounting fasteners 20. In particular, in the shown embodiment, the isolator body 1a includes two through holes 2 for two pump mounting fasteners 20 (i.e. one pump mounting fastener 20 for each through hole 2). The through holes 2 for the pump mounting fastener 20 are typically threaded holes intended to receive threaded fasteners, e.g. screw. In preferred embodiments, there is more than one through hole 2 for the pump mounting fasteners 20. In the shown embodiment, there are two through holes 2 for two relevant pump mounting fasteners 20.

According to an embodiment, two through holes 2 are spaced one to the other by a distance D1. Such a distance is equal to the distance D0 between the pump mounting fasteners 20 when they are coupled to the fuel unit pump 180, typically to the pump mounting flange 180a of the fuel unit pump 180.

The shape of the isolator 1, an in particular of the isolator body 1, may vary between different embodiments. Preferably, a dimension TD1 of the isolator 1 matches the maximum dimension PMF1 of the pump mounting flange 180a. In the shown embodiment, in plant view, the two dimensions TD1 and TD2 of the isolator are substantially equal one to the other. Sides TDa, TDb, TDc and TDd of the isolator 1 are convex, so that, in plant view, the isolator (and in particular the isolator body 1a) is shaped as a four pointed star.

According to an embodiment, the isolator 1, and in particular the isolator body 1a, is provided with a through opening 6. The through opening allows passage of a fuel pump pumping plunger in operative condition through the isolator. The isolator 1 is also provided with one or (preferably) more engine coupling portions 1b configured to be coupled to an engine structure 111 of the internal combustion engine 110.

The engine structure can be any engine portion suitable to be operatively coupled to the fuel unit pump 180. Typically, the engine structure 111 is the cylinder head 130. In an alternative embodiment it may be the engine block 120.

In the shown embodiment, the isolator 1 is provided with two engine coupling portions 1b. The engine coupling portions 1b protrude from the isolator body 1a so that, when the isolator 1 (and thus the fuel unit pump) is coupled to the engine structure 111, the isolator body 1a is distanced by an operative distance OD from the engine structure 111 itself. The coupling portions 1b protrude from the second surface 12 of the isolator body 1a, i.e. the surface opposite to the surface coupled to the pump mounting flange 180a.

The shape of the engine coupling portion 1b may vary between different embodiments. In the shown embodiment, the engine coupling portion 1b is a cylindrical protrusion. According to an embodiment, the engine coupling portion(s) is/are provided with a through hole 3 for an engine mounting fastener 30.

Typically, the engine mounting fastener(s) 30 is/are centering bolts, to allow easy piloting of the fuel unit pump assembly 10 during assembling of the latter to the engine structure 111. Such a piloting function could also be achieved by e.g. piloting dowel(s), pilot pin(s), or combinations thereof, which may or may not be removable depending on isolation and mounting requirements.

According to an embodiment, at least a portion of the fuel unit pump protrudes into the engine, and thus it may also provide for the above mentioned pivoting function.

According to an embodiment, an isolator 1 is provided with two through holes 3 distanced one to the other by a distance D2.

The engine structure 111 is in turn provided with holes 4 (typically threaded holes) for receiving the engine mounting fasteners 30, and the holes 4 are in turn distanced one to the other by a distance D3. Distance D2 between the through holes 3 of the isolator 1 is equal to distance D3 of the engine structure to allow coupling between the isolator 1 and the engine structure 111 itself.

According to an embodiment, the distance D2 between two through holes 3 for the pump mounting fasteners 20 is substantially equal to the distance D1 between two through holes 2 for the pump mounting fasteners 20. As a result, it is possible to use the isolator with pre-existing configurations of a fuel unit pump and an engine structure. In other words, according to previous configurations, the engine structure was provided with holes 4 distanced by a distance D3, while the pump mounting fasteners were coupled to the fuel unit pump 180 at a distance D0 one to the other; distance D0 was equal to distance D3 to allow coupling between the fuel unit pump 180 and the engine structure 111.

According to the above mentioned embodiment, D0 is equal to D1, which is in turn equal to D2, which is in turn equal to D3. As a result, a pre-existing fuel unit pump 180 (instead of being coupled directly to the engine structure, typically by means of the pump mounting flange 180a) can be mounted to the isolator 1, by means of the pump mounting fasteners 20 coupled to the through holes 2, because distance D1 is equal to distance D0. The so assembled fuel pump assembly 10 can be mounted to a pre-existing engine structure 111, provided with holes 4 distanced by a distance D3, originally meant to receive the pump mounting fasteners 20 distanced by a distance D0.

On the contrary, in the present embodiment, the isolator 1 is coupled to the engine structure 111, via the engine mounting fasteners 30, which are coupled to the through holes 3, and thus distanced by a distance D3, which is equal to the distance D0.

In other embodiments, distance D2 may be different from distance D3. As a result, the isolator 1 may also serve as an adapter coupling a fuel unit pump having pump mounting fasteners 20 distanced by a distance D0 which is different from the distance D3 between the holes 4 of the engine structure 111.

According to an embodiment, the isolator 1 includes one or more stiffness adjusting recesses or openings 5 to adjust the stiffness of the isolator 1 itself. In particular, the stiffness adjusting recesses or openings 5 reduce the stiffness of the isolator 1 in pre-determined areas. In other embodiments, stiffness adjusting embossments may be used to increase the stiffness of then isolator is certain areas. In general, the geometry of the isolator 1 can be varied significantly depending upon e.g. the isolation frequency required, durability requirements, fuel unit pump mass, internal combustion engine and fuel unit pump mounting geometries. Preferably, the stiffness adjusting recesses or openings 5 allow to adjust the stiffness of the isolator 1 as in the shown embodiment, where two stiffness adjusting elements 5 (i.e. two openings) are present on the isolator 1.

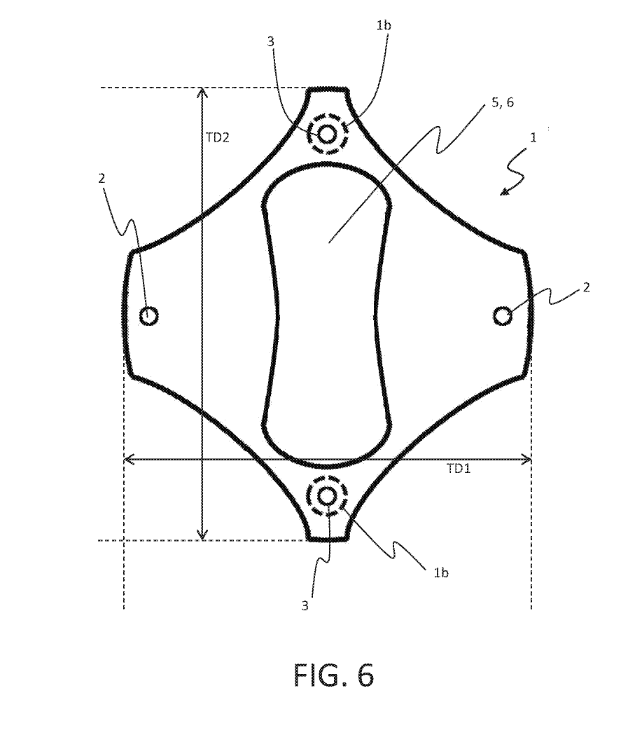

In the shown embodiment, the stiffness adjusting recesses or openings 5 are separate from the through opening 6. In different embodiments, they can be a unique element, as shown in FIG. 6, where the same references of the previous embodiment are used. In other words, a single opening can serve as a through opening for a fuel pump pumping plunger and as a stiffness adjusting opening. In general, the shape and material of the isolator 1 can be chosen so as to isolate the fuel unit pump 180 vibration energy from the engine structure 111, in order to reduce the overall noise and ticking contribution radiating from the internal combustion engine 110. In particular, the isolator 1 is configured (i.e. it is “tuned”) so as to isolate the fuel unit pump vibration from the engine structure. Preferably, such an isolation allows the fuel unit pump 180 to vibrate at high frequencies and low displacements. This vibration allows the pump to dissipate its own energy. The isolator can be quite stiff because the frequencies to isolate are very high (i.e. greater than 2000 Hertz).

As an example, the stiffness of the isolator can be calculated as:

$$k \leq \frac{{ω}^{2} M}{2}$$

wherein:
k is the isolator stiffness;
M is the mass of the fuel unit pump (possibly added to the mass of the digital flow control valve, if present); and
ω is a frequency chosen so as to be greater than or equal to the engine firing frequency, multiplied by the square root of 2.

During assembling, the fuel unit pump mounting flange 180a is coupled to the first surface 11 of the isolator body 1a by the pump mounting fasteners 20, to form a fuel unit pump assembly 10. The fuel unit pump assembly 10 is then coupled to the engine structure 111 via the isolator 1, by the engine mounting fasteners 30.

During use, the fuel unit pump 180 vibrations are isolated from the engine structure 111 by the isolator 1. Also, the fuel unit pump 180 is coupled to the engine structure 111 via the isolator 1, so as to reduce the direct transmission of vibrations between the fuel unit pump 180 and the engine structure 111.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-7. (canceled)

8. A fuel unit pump assembly comprising:
a fuel unit pump including a pump mounting flange protruding from a pump body; and
an isolator including an isolator body having a substantially plate shape with at least one through hole configured to receive a pump mounting fastener for coupling the pump mounting flange to a first surface of the isolator body, the isolator further including at least one engine coupling portion protruding from a second surface of the isolator body, opposite said first surface, with at least one through hole configured to receive an engine mounting fastener for coupling the isolator to an engine structure of an internal combustion engine.

9. The fuel unit pump assembly according to claim 8, wherein the isolator comprises a through opening for inserting at least a pumping plunger of the fuel unit pump through said through opening.

10. The fuel unit pump assembly according to claim 8, wherein said engine mounting fastener comprise a centering bolt.

11. The fuel unit pump assembly according to claim 8, wherein the isolator body comprises two through holes configured to receive pump mounting fasteners and spaced apart by a distance substantially equal to the distance between two through holes for engine mounting fasteners.

12. The fuel unit pump assembly according to claim 8, wherein said isolator comprises at least one stiffness adjusting element configured to adjust the stiffness of said isolator.

13. The fuel unit pump assembly according to claim 12, wherein said stiffness adjusting element comprises at least one of a recess or an opening.

14. An internal combustion engine comprising
an engine structure;
a fuel unit pump including a pump mounting flange protruding from a pump body; and
an isolator including an isolator body having a substantially plate shape with at least one through hole configured to receive a pump mounting fastener for coupling the pump mounting flange to a first surface of the isolator body, the isolator further including at least one engine coupling portion protruding from a second surface of the isolator body, opposite said first surface, with at least one through hole configured to receive an engine mounting fastener for coupling the isolator to the engine structure.

15. An internal combustion engine according to claim 14, wherein the engine structure comprises a cylinder head and the fuel unit pump assembly is coupled to the cylinder head.
